(19) United States
(12) Patent Application Publication
(10) Pub. No.: US 2013/0238796 A1
(43) Pub. Date: Sep. 12, 2013

(54) SYSTEM AND METHOD FOR PROVIDING SOCIAL DIGITAL VIDEO RECORDING

(71) Applicant: COMIGO LTD., Yarkona (IL)

(72) Inventor: MOTTY LENTZITZKY, RAANANA (IL)

(73) Assignee: COMIGO LTD., YARKONA (IL)

(21) Appl. No.: 13/787,905

(22) Filed: Mar. 7, 2013

Related U.S. Application Data
(60) Provisional application No. 61/607,617, filed on Mar. 7, 2012.
(60) Provisional application No. 61/607,615, filed on Mar. 7, 2012.
(60) Provisional application No. 61/611,024, filed on Mar. 15, 2012.
(60) Provisional application No. 61/611,030, filed on Mar. 15, 2012.
(60) Provisional application No. 61/643,372, filed on May 7, 2012.
(60) Provisional application No. 61/643,375, filed on May 7, 2012.

(51) Int. Cl. H04L 12/24

(52) U.S. Cl. CPC H04L 41/12
USPC 709/225

(57) ABSTRACT

Systems and methods for managing DVR content in media based social network environments such as social television. Access to a DVR may be provided via client terminals such as televisions, STBs, tablets, computers and the like. Remote access and remote recording permissions, which may be content dependent, may be assigned to social entities such as social contacts, members of social groups and social groups themselves. Accordingly, social entities may be granted rights to record to or read from DVRs associated with a user.

### CROSS-REFERENCE TO RELATED APPLICATIONS

This application claims the benefit of priority from U.S. Provisional Patent Application 61/607,617 filed Mar. 7, 2012, U.S. Provisional Patent Application 61,607,615, filed Mar. 7, 2012, U.S. Provisional Patent Application 61/611,024 filed Mar. 15, 2012, U.S. Provisional Patent Application 61/611,030 filed Mar. 15, 2012, U.S. Provisional Patent Application 61/643,372 filed May 7, 2012, and U.S. Provisional Patent Application 61/643,375 filed May 7, 2012 the contents and disclosures of which are incorporated by reference in their entirety,

### FIELD OF THE INVENTION

The invention relates to the use of a digital video recorder (DVR) as an online recording device of digital content, enhancing the television as a social medium. In particular, the disclosure relates to providing members of a social group, the permissions for managing remote DVR features of content recording.

### BACKGROUND OF THE INVENTION

Digital Video Recorders (DVRs) are used in various configurations, for example, as entertainment devices or the like. A DVR is an excellent tool for enjoying media content, offering tremendous flexibility for viewing television content, and providing a consumer with control over what to watch, at what time and for what duration. The DVR may enable the consumer to select content to record, and the duration of the recording, to schedule repeated recording and the like. Furthermore, DVRs may reduce or eliminate the need for VCR devices, reduce the need to flick through channels or may allow skipping commercials, for example. Additionally, DVRs may support a higher degree of personalization and integration with other devices. Indeed DVRs may have the potential to change the way people consume television content.

Television is a wide reaching vehicle and a highly significant player in the digital media content domain. Recent studies of consumer behavior and television measurements (eMarketer—Digital Intelligence, Nielsen) claim that 99% of American households watch television on a regular basis. Furthermore, the studies highlight the fact that the average duration of adults watching television is higher than online surfing; four and half hours per day compared to an average of just two and half hours per day. Additionally, the percentage of American homes having at least one television set is reaching 99%, with two thirds of them owning at least three sets. These numbers highlight the fact that television is still a most widespread and premier entertainment platform.

DVRs may be capable of recording media content of various types; television programs, audio content, visual content, audiovisual content, multimedia content and the like, for example by saving them onto a recording device such as a hard drive for a later use. Such content may be subsequently used for playback, viewing, editing or the like. The viewing of the playback content of a recorded television program may be referred to as “time-shifted” television watching. This term, may also include playback from VOD, DVD recorders, server based DVR's services and the like. Additionally, while recording, users may switch to view other television programs or to various other media modes.

Advancement of technology enables DVRs to be networked with other peripherals at home, such as the home computer, for example. Networking a DVR may involve a wireless adapter connecting a set-top box (STB) with a homes' wireless network, a personal computer or the like. Once a network has been established, files may be transferred from the DVR to a computer or other media storage device.

The DVR may offer greater convenience to the consumer and may complement the advancement of technology such as flat screen television, high definition broadcasting, tablet computers, smart telephones, mobile communication devices with web access and the like to further the quality of the media consumer experience. As video content has become more extensively available for viewing through cables. Satellites or via the web, as well as other channels offering various options, it has been noted that DVRs have progressed from a novelty to an increasingly mainstream technology. Furthermore, DVR playback contributes significantly to overall television usage, and time-shifted television watching has become more relevant.

### SUMMARY OF THE INVENTION

It is according to a first aspect of the current disclosure to teach a method for assigning a recording permission for at least one remote client terminal. The method comprises the steps: displaying an activity interface for a local client terminal; selecting a social entity; selecting a first permission attribute with respect to the social entity; and assigning, with respect to the local client terminal, the recording permission for the at least one remote client terminal associated with the social entity based on the first permission attribute.

Optionally, the method may further comprise the steps of: selecting a content tag; selecting a second permission attribute with respect to the content tag; and assigning, with respect to the local client terminal, a recording permission for the at least one remote client terminal associated with the social entity based on the second permission attribute.

Variously, selection of the social entity may be conducted through a method selected from the group consisting of: keyword searching, navigating menus having lists of potential social entities.

Where appropriate, the selection of the social entity may be preceded by a presentation of one or more suggested social entities. Accordingly, the one or more suggested social entities may be presented through the activity interface of the local client terminal. Additionally, or alternatively, the one or more suggested social entities may be presented through one or more vehicles selected from the group consisting of: email, website advertisements, popups, interactive television advertisements. Particularly, the vehicle may comprise a link to the activity interface for the local client terminal. Optionally, the one or more suggested social entities may be selected based on a preference profile assigned to the local client terminal. Accordingly, the selection of the one or more suggested social entities are selected based on the preference profile of the one or more suggested social entities.

Variously, the social entity may be selected from the group consisting of: a social group, a social set, and a social group member. The media content may be television shows, radio shows, podcasts, downloads, movies, video clips, slideshows, multimedia presentations, pictures, games, music, audio clips as well as combinations thereof and the like. Optionally, the client terminal comprises, a television set, a set-top-box (STB), a desktop computer, a laptop computer, a tablet, a telephone, a PDA, a mobile communication device and the like as well as combinations thereof.

Optionally, the permission attribute is selected from the group consisting of: ‘NONE’, ‘ALLOWED’, ‘NOT ALLOWED’, ‘WRITE’, ‘READ’, and ‘READ-WRITE’, wherein: ‘NONE’ is a default permission attribute configured to not allow remote recording; ‘ALLOWED’ is configured to grant permission for the selected social entity to remotely record media content onto the DVR device of the client terminal; ‘NOT ALLOWED’ is configured to block the recording of media content that would otherwise be granted for remote DVR recording with the client terminal; ‘READ’ is configured to allow the selected social entity to remotely record media content onto the DVR device of the client terminal but not allow the client terminal to remotely record media content for the selected social entity; ‘WRITE’ is configured to allow the client terminal to remotely record media content for the selected social entity but not allow the selected social entity to remotely record media content onto the DVR device of the client terminal; and ‘READ-WRITE’ is configured to allow the client terminal to remotely record media content for the selected social entity and to allow the selected social entity to remotely record media content onto the DVR device of the client terminal.

According to another aspect of the disclosure a method is taught for controlling recording activity in one or more remote client terminals having the steps of: displaying an activity interface of a local client terminal; selecting a target social entity; selecting a target media content; and instructing at least one remote client terminal associated with the target social entity to record the target media content.

Optionally, the method further comprises the step of performing a recording request validation for the one or more remote client terminals associated with the target social entity. Accordingly, the recording request validation may be based on one or more permission attributes assigned to the local client terminal with respect to the target social entity.

Additionally, or alternatively, the method may further comprise the step of assigning one or more content tags to the target media content. Accordingly, the recording request validation may be based on the content tags associated with the target media content.

The method may further comprise the step of sending a message to the at least one remote client terminal.

Optionally selection of the target social entity and the selection of the target media content may be conducted through a method selected from the group consisting of: keyword searching, navigating menus having lists of potential social entities.

Optionally, the selection of the target social entity and the target media content may be preceded by a presentation of one or more suggested social entities and one or more suggested media content. Accordingly, the one or more suggested target social entities and the one or more suggested target media content may be presented through the activity interface of the local client terminal. Optionally, the one or more suggested target social entities and the one or more suggested target media content may be presented through one or more vehicles selected from the group consisting of: email, website advertisements, popups, interactive television advertisements. Where appropriate, the vehicle may comprise a link to the activity interface for the local client terminal. Optionally, again, the one or more suggested target social entities and the one or more suggested target media content may be selected based on a preference profile assigned to the local client terminal. Additionally or alternatively, the selection of the one or more suggested target social entities and the one or more suggested target media content may be further based on the preference profile of the one or more suggested social entities.

Variously, the social entity may be selected from the group consisting of: a social group, a social set, and a social group member. The media content may be television shows, radio shows, podcasts, downloads, movies, video clips, slideshows, multimedia presentations, pictures, games, music, audio clips as well as combinations thereof and the like. Optionally, the client terminal comprises, a television set, a set-top-box (STB), a desktop computer, a laptop computer, a tablet, a telephone, a PDA, a mobile communication device and the like as well as combinations thereof.

According to other aspects of the disclosure a computer program product is presented which is embodied in a computer readable medium that, when executing on one or more computers, performs the steps of: displaying an activity interface for a local client terminal; selecting a social entity; selecting a first permission attribute with respect to the social entity; and assigning, with respect to the local client terminal, the recording permission for the at least one remote client terminal associated with the social entity based on the first permission attribute.

According to still other aspects of the disclosure a system is presented comprising one or more computers configured to perform the steps of: displaying an activity interface for a local client terminal; selecting a social entity; selecting a first permission attribute with respect to the social entity; and assigning, with respect to the local client terminal, the recording permission for the at least one remote client terminal associated with the social entity based on the first permission attribute.

### BRIEF DESCRIPTION OF THE DRAWINGS

For a better understanding of the embodiments and to show how it may be carried into effect, reference will now be made, merely by way of example, to the accompanying drawings.

With reference now to the drawings in detail, it is stressed that the particulars shown are by way of example and for purposes of illustrative discussion of selected embodiments only, and are presented in the objective of providing what is believed to be the most useful and readily understood description of the principles and conceptual aspects. In this regard, no attempt is made to show structural details in more detail than is necessary for a fundamental understanding; the description of the drawings making apparent to those skilled in the art how the various selected embodiments may be put into practice. In the accompanying drawings:

FIG. 1 is a block diagram representing one possible configuration of selected elements of a system for content-based management of a media renderer with local processing of social DVR management system;

FIG. 2A is a block diagram representing another possible configuration for a distributed network-based system for content based management of a media renderer with central processing of social DVR management system;

FIGS. 2B and 2C schematically illustrate examples of a shared media session managed by a central server for a social set of users;

FIG. 3 is a flowchart representing possible formation of modules to support the disclosure of remote recording functionality;

FIG. 4 is a flowchart representing selected actions of a method for providing social user configuration of recording permission; and

FIG. 5 is a flowchart representing selected actions of a method for providing social recording remotely.

### DETAILED DESCRIPTION OF THE INVENTION

Time-shifted television watching using DVR (digital video recorder) playback is becoming more established, as described hereinabove, aiming at changing the nature of television viewing. During the last few years, various developments have been made to provide television services on a social basis taking advantage of the relationship between individuals, connecting users watching public television content in different locations. The combination of television running alongside a DVR application may offer significant advantages.

The present disclosure may provide an additional mode of operation enabling use of television and DVR such that watching any desired television content, anytime, may be facilitated. In particular, the present disclosure enables controlling a media renderer, such as a television, using advanced social remote recording. The use of analytical tools and/or statistical analysis and/or machine learning algorithms may make the social interaction experience more pertinent, answering user preferences more effectively. Furthermore, the enhancement of remote recording functionality by social group members may have a significant impact. It may contribute to changing the way television content is consumed with respect to time, content and the like. Additionally, from advertisers' perspective, DVR remote program recording may have a surprisingly positive impact on consumer shopping behavior.

Aspects of this disclosure are based on technological infrastructure for controlling media renderers such as televisions, according to content available, user preferences and social information mechanisms. Additionally, it is related to making the time-shifted television viewing a more realistic and convenient experience, and the television itself more of a social media. People socialize within a shared social space, and the methods and systems of communication between television viewers with current disclosure of remote recording implementation may better facilitate the television as a real social engagement platform.

Definitions

As used herein, a user refers to an individual (or a group of individuals) operating a system or a component thereof of the disclosure (e.g., a client terminal) or performing a method of the disclosure.

As used herein, an owner refers to an individual (or a group of individuals) that is associated with a particular client terminal.

As used herein, a social group comprises one or more members. A member may be an individual or a group of individuals. A social group may be classified, for example, according to various preferences, tastes or interests of social spaces. One or more members of the social group may be authorized, by assigning permission, to perform remote recording of desired content in the system of one or more other members of the social group, or may be narrowed to specific categories only.

The social group, or a subset thereof, may be a social set, which is defined herein as a set of members that are configured to view a shared media session. The shared media session is a media content that is configured to be viewed simultaneously (or recorded) by members of the social set to which the shared media session is assigned. One shared session may be assigned to one or more social sets.

The social group, the social set, and the individual member of a social group may be referred to, generically, as a social entity. A social group comprises one or more members. A social set comprises one or more members within a social group assigned to a shared media session. The various social entities may be nested. That is, one or more members may be included into a social group or a social set, and one or more social sets may be included in a social group.

A user may be a member, and a member may be a user.

As used herein, media content may be any information content that may be experienced by a user, including but not limited to television shows, radio shows, movies, video clips, slideshows, multimedia presentations, pictures, games, audio content, music, and the like.

As used herein, a client terminal is a device that is operable to meet user defined preferences, monitor available media content and/or control the media content input to a media renderer. The client terminal may include, or be externally connected to, a digital video recorder (DVR). A client terminal may comprise, be connected to, be incorporated into or be otherwise associated with, without restriction, a television set, a set-top-box (STB), a desktop computer, a laptop computer, a tablet, a telephone, a mobile communication device or the like. A set-top box (STB) is an information appliance that connects to a television set and an external source of signal, decoding that signal into content that can be presented on a television screen or other display device as media content. The STB may be a cable television STB. As used herein, a DVR is a device that is capable of recording media content of various types; television programs, audio content, visual content, audiovisual content, multimedia content and the like, for example by saving them onto a recording device such as a hard drive for a later use. Such content may be subsequently used for playback, viewing, editing or the like. The DVR may variously include a local data storage unit, a remote data storage unit accessible by a media renderer client terminal or the like. The DVR may additionally or alternatively include a device configured for playback from VOD, DVD recorders, server based DVR's services and the like. Additionally, while recording, users may switch to view other television programs or to various other media modes.

As used herein, a media renderer is a device that is operable to present media content into a consumable form (e.g., visible, audible and the like). The media renderer may be one or a combination of, without restriction, television sets, monitors, speakers or the like.

Social DVR functionality

Social DVR functionality may provide a selected group of members of a social group, subject to given permissions, to record streamed data on a remote device such as another member's client terminal, such as a STB or the like. Recording may be performed remotely by the owner or any authorized person to whom appropriate permissions have been given.

The interaction with the user via a user-friendly interface may be driven by a management module. Additionally, it may work in different possible architectures, for example using a network-based approach to allow remote activities.

Furthermore, there may be several factors influencing social DVR functionality. Time and content are particularly pertinent, but there may be other factors. Thus, it may contain different functionality such as instant recording or delayed recording of diverse content.

Time, as a key factor, may represent time of the day and duration of recording, but may also be used differently. Delayed recording, for example, may be preset in relative terms, to start at some time span from current time or may specify a starting time defined by date and time.

Content may be identified by reference to a media channel, for example. Alternatively or additionally content may be identified by a name, number, broadcast time or other designator of a program or content type. The content may be associated with a recording operation or selected from a broadcasting schedule or the like. Content may be recorded, periodically for example daily, weekly or monthly or the like according to definitions or may follow some other schedule determined therefor.

Where required, a dedicated DVR application (i.e., a DVR management software) may be provided specifically to manage remote recording functionality. Alternatively or additionally, the application maybe integrated with other features of a social platform, for example, such as described in the applicants co-pending applications relating to group purchasing and hybrid advertising PCT Patent Application No. PCT/IL2013/050186 which is incorporated herein by reference.

It is noted, while the DVR application is in recording mode, users may simultaneously switch between different television programs or various other media types, such as television, music, gaming content and the like. Thus, for example, when remote recording is activated on any client terminal in a social space, a user may perform a variety of activities such as monitoring progress of the recording, switching to another channel, accessing other media, social communicating or the like.

It is noted that DVR may have impact related to television commercials. Advertising on television allows introduction to a wide audience of a business, product, or service, conveying a message with visuals, sound and movement often reaching consumers at their most attentive and alert time. Contrary to those who fear that DVRs would wipe out the value of commercials, due to viewers fast-forwarding through advertising, DVRs contribute significantly to commercials viewing.

### DVR Management Software

The architecture of the social DVR management software may include various functional modules such as a management module, a social configuration module, a permission module, a recording module and the like. Optionally and additionally, social DVR management software may be integrated into one or more other expanded social television platforms.

The management module may control recording functionality, data reception and communications with the other modules.

The social configuration module may allow the social environment to be configured to suit requirements. For example, configuring of the social environment may include the creation of social groups, adding or removing members of social groups, defining permissions, editing related social information of members or the like. The social configuration module may be implemented to provide lightweight and basic architecture or optionally, may be integrated with other social modules, for example, such as described in the applicant's co-pending application relating to group purchasing and hybrid advertising U.S. Ser. No. 61/605,220.

The recording module may be provided to manage the recording or storage of media content data, for example initiating ad hoc recording or setting scheduled recording. The recording module may also provide monitoring of current on-going recording schedule of DVRs. Monitoring may provide recording details such as start time, recording duration, recording progress, message tracking, completed recordings and the like.

The permission module may be provided to manage the assignment of permissions to members of the social space.

Permission attributes assigned to members of the social space may involve a straight forward definition of ‘ALLOWED’ or ‘NOT-ALLOWED’ for performing remote recording. Alternatively or additionally, the permission constructs may support a wider range enabling enhanced functionality. Such definitions, for example, may comprise a variety of permission attributes such as ‘NONE’, ‘WRITE’, ‘READ’, ‘READ-WRITE’ and ‘DELETE’. ‘NONE’ may serve as a default attribute, not allowing any remote recording functionality. ‘WRITE’ may grant permission for recording new content only. ‘READ’ may allow viewing of recorded content only and ‘READ-WRITE’ may allow recording and viewing as described hereinabove. ‘DELETE’ may allow removing of recorded programs to manage DVR space limitations issues. Space limitation may be of concern regularly, but especially when recording high definition programs as a HD DVR.

It is further noted that such permission attributes may be content or contact dependent. Accordingly, a particular member of the social space may be provided content dependent permission to record data to a user's DVR or to access recorded data from a user's DVR. For example, a member of the social space may be provided with specific permission attributes allowing the member to read data only if the data is tagged, labeled or otherwise associated with a particular content type.

### User Preference Profile

The interests of a viewer may be reflected through a user preference profile. User preference profile may serve, additionally, in the recording context as a tool for building categories to satisfy tastes and interests of the client terminal owner. The user preference profile may be created and configured manually or automatically. Manual configuration may designate categories of interests and the like, while automatic configuration may require machine learning algorithms or statistical analysis tools to deal with its complexity and high dimensionality.

Additionally or alternatively, the automatic configuration process may score for each item of interest, for example, based on a number of watching times or the like.

The configuration process for the user preference profile may be expanded to include collaborating information. Thus, the configuration process may include the collection of data relating to user preferences. Optionally, it may also include personal tastes of multiple users (e.g., a household) sharing a common television set or simultaneously viewing the same content on different television sets or in different locations. Data filtering, in any of its forms, may produce a number of recommendations, such as a household preference profile, personal preference profile or other data structure reflecting viewers' preference. The form of recommendations may provide personalized targeting, and measurement capabilities to assess the impact of television advertising and its performance.

For manual configuration of the user preference profile, the management module may drive the interaction with the user via a user-friendly interface. Additionally, the configuration process may work in different possible architectures, such as network based approach as described herein, to allow for the configuration of the user preference profile through remote activities.

Further, the preference profile may be utilized to generate suggestions for social entity selection and media content selection for social DVR recording activity.

### Setting Social DVR Recording Activity

The social DVR feature may allow, for illustrative purposes, several possibilities for setting the recording activity of the social DVR. Such possibilities may be, for example: setting recording categories; assigning permissions for recording; time for delayed recording; monitoring recording progress; management of the social environment and the like.

Media management systems such as those described herein may communicate related information to the user via an overlay superimposed upon the screen of a television set or other media renderer.

System Components

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data.

Optionally, a network connection may additionally or alternatively be provided. User interface devices may be provided such as visual displays, audio output devices, tactile outputs and the like. Furthermore, as required, user input devices may be provided such as remote controls, keyboards, cameras, microphones, accelerometers, motion detectors or pointing devices such as mice, roller balls, touch pads, touch sensitive screens or the like.

Optionally, with the introduction of Wi-Fi integrated chipset into televisions, enhanced user interface may use smart phones, tablet or other sophisticated devices to make the recording experience easier and friendlier, enriching implementation functionality.

Optionally, a system may include a client terminal such as a set-top-box (STB), mobile communication device or the like, possibly with web access, which is operable to meet user defined preferences, monitor available media content and control the input to a media renderer, accordingly.

### System Embodiments

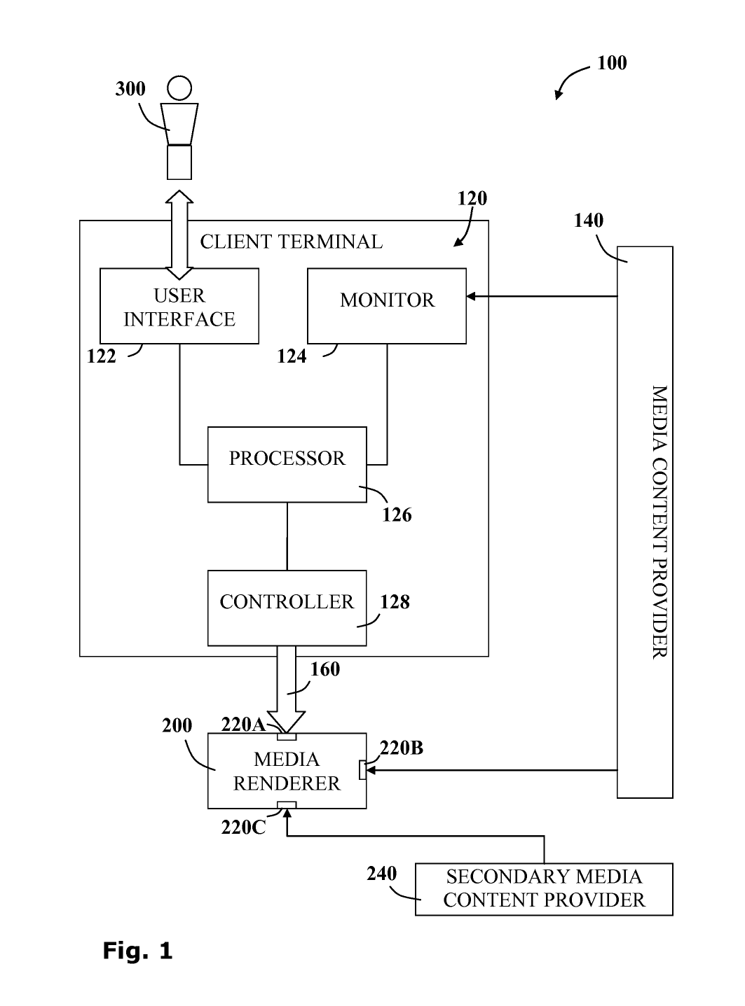

With reference to FIG. 1, showing a block diagram representing the main components of one possible configuration of selected elements of a media management system 100 for content based control of a media renderer 200. This configuration may have added functionality of stream of adverts, locally processed and managed, for example such as described in the applicants co-pending applications relating to hybrid advertising, the contents of which are incorporated herein by reference. The media management system 100 includes a client terminal 120 in communication with a media content provider 140 connecting to the media renderer 200 via a communication channel 160. The client terminal 120 includes a processor 126 and may include additional components such as a controller, a user interface and a media monitor.

Optionally, a user interface 122 of the client terminal 120 may be used to allow a media consumer 300 setting preferences to be used by the media management system 100 selecting control signals sent to the media renderer 200. Various user interfaces 122 are known in the art such as keyboards, touch screens, remote controls, pointing devices and the like and may be used to input data to the client terminal 120. Optionally, the media renderer 200 itself may serve as at least part of the user interface 122, for example, by providing an output screen or input device.

The processor 126 of the media management system 100 is operable to receive media content data from the media-monitor 124, and to record a user preference profile related to media content accessed. The controller may further select control signals which the controller 128 may send to the media renderer 200. It is particularly noted that the media management system 100 may be managed by application software executed by a computing device such as a computer, telephone, television, STB or the like.

It is noted that the media renderer may comprise a plurality of connector ports 220A-C which may be connected to a number of media sources. For example, a first port 220A may be connected to the client terminal 120, a second port 220B may be connected to the media content provider 140 and a third port 220C may be connected to a secondary media content provider 240.

The filtering and recommendation of the television social functionality categories may be controlled by a user preference profile, for example, generated by a software package running on the client terminal processor 126, or customized manually. Such a preference profile may reflect the categories and preferences of viewing throughout the day and may indicate potential desired product or service for the user. The preference profile may be stored locally or may be sent to the media content provider for remote storage. The product/service offering stream to the client terminal may be filtered or may be adjusted to suit user preference profile to meet social functionality preferences.

The user's preference profile may reflect categories of preferences of viewing and purchasing, based on program content or may be configured individually to indicate distinction. It is also noted that a user preference profile may be personalized for a user or a client terminal itself. Where a client terminal is associated with stationary hardware such as a television or STB, it may be useful to create a detailed preference profile for the client terminal reflecting, say, the viewing habits and purchasing preferences of a household. It is noted that the user preference profile may provide for a selection of adverts or purchasing to be selected based upon statistical analysis of the viewing habits of the whole household. This preference profile may contain additional attributes with respect to “Recording” with different relevant fields. Optionally, it may contain a permission field.

In some embodiments, a media stream may be accessed directly by a media renderer, for example, via the second input port 220B. It will be appreciated that where the client terminal is connected to the media renderer 200 via the first port 220A, it will not have control over content accessed via the second input port 220B.

By way of illustration only, control signals may use the Consumer Electronics Control (CEC) feature available for example, with HDMI connections or the like. The CEC feature may provide a controller 128 to command and control the media renderer 200 by sending control signals via the client terminal 120. For example, CEC Routing Control allows a user to control the switching of signal sources between input channels.

Where required, the controller 128 may be operable to send control signals switching the input channel of the media renderer 200 to the first input port 220A as required. Accordingly, a personalized advert stream may be sent from the client terminal 120 to the media renderer 200 via the first input port 220A for the duration of the advertising break in the media content stream. Optionally the media management system 100 may be further operable to switch access back to the second port 220B at the end of the advertising break, alternatively, the media content stream may be provided to the media renderer 200 via the client terminal 120.

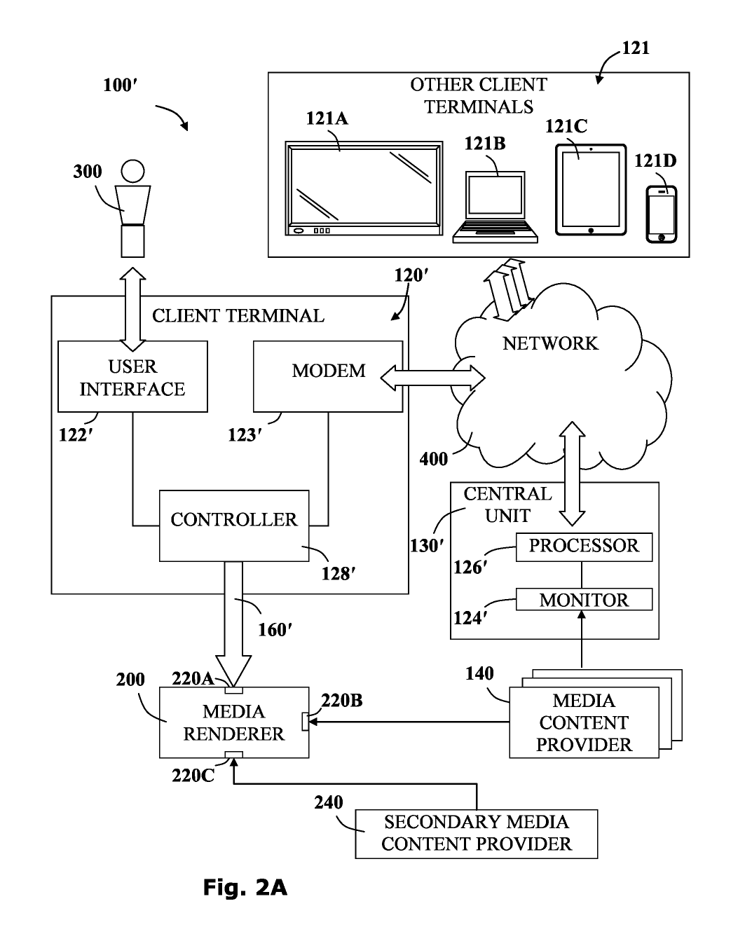

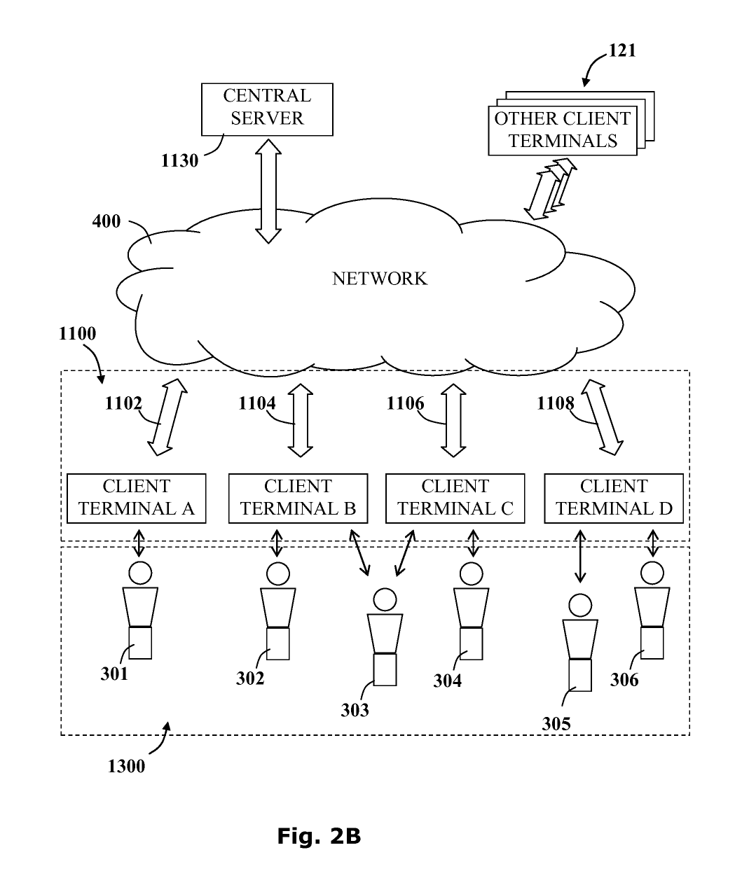

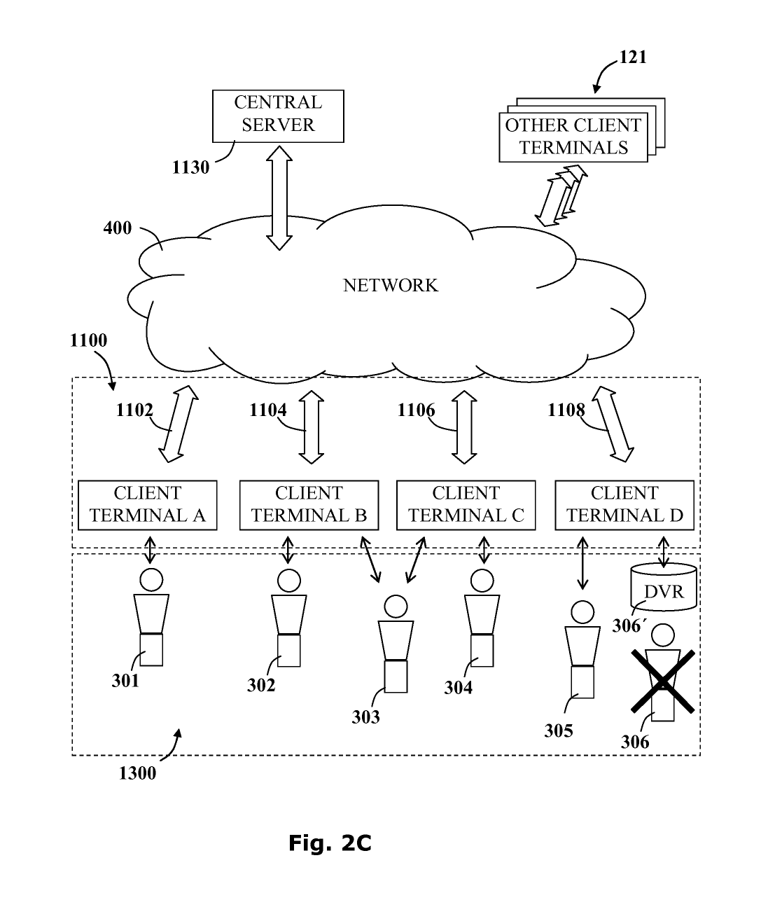

Referring now to FIG. 2A, showing another possible block diagram configuration for a media management system 100′ that is network-based and distributed, for content based control of a media renderer 200 with added functionality of group purchasing, centrally processed and managed. The network-based distributed media management system 100′ includes a client terminal 120′ and a central unit 130′ in communication with a network 400, such as the World Wide Web, or a local area network or other such networked computing system.

The central unit 130′ may provide specific functionality of group recording processing of the network-based distributed media management system 100′ to be performed remotely and communicated to the client terminal 120′ via a modem 123′ providing a connection to the network 400. For example, the central unit 130′ may be operable to receive media content data from a media-monitor 124′, and to record a user preference profile related to media content accessed. The central unit 130′ may further have a processor 126′ receiving information, such as the current viewer preference profile (with targeting characteristics) created locally on the client terminal 120′ or TV associated events from the client terminal 120′ to process and update user preference profile (with targeting characteristics) on the central unit 130′, controlling group purchasing content sent to this client terminal.

It is noted that for network-based architecture as indicated in FIG. 2A, some of the analytics may be performed on the controller of the terminal client. This may, for example, establish and maintain a local user preference profile. Alternatively or additionally, the media management system 100′ may send data pertaining to a viewer's watching behavior to the central unit 130′ and a user preference profile may be generated and maintained remotely.

It is further noted that a number of different client terminals 121 may access a common central unit 130′ possibly via a network 400 such as the internet or the like. Accordingly, a social set of users using a variety of client terminals such as televisions 121A, computers 121B, tablets 121C, telephones 121D or the like, may be connected via the common central unit 130′ as described herein.

Although two different architectures are described herein for illustrative purposes, those skilled in the art will appreciate that other technologies may be used to implement the method of controlling group recording.

Referring now to the block diagram of FIG. 2B, the network-based architecture may use a central server 1130 to manage a shared media session 1100 for a social set 1300 of selected users 301-306. Each user is connected to the central server 1130 by at least one client terminal such as described hereinabove.

A social set 1300 may be created, for example by a user inviting selected members of a social group to participate in a shared media session 1100. Alternatively or additionally, the members of a social set 1300 may be generated automatically.

A shared media session 1100 may centrally manage the network communication channels 1102, 1104, 1106, 1108 between participating client terminals and the central server 1130. Accordingly, the member users of the social set 1300 may access a common media broadcast. Furthermore, the members of the social set may access a common social space providing interaction such as chat, VOIP or the like during the shared media session.

It is noted that members of a common social set 1300 may have common interests and the shared media session 1100 may serve as a useful platform for group purchases. For example, a group of users all simultaneously viewing a sports match or the like may be interested in purchasing tickets to a future fixture. Similarly, because the media is accessed concurrently by all members of the social set, a timely offer may be made by a vendor or initiated by at least one member of the social set.

With reference now to FIG. 2C, the social set 1300 of FIG. 2B is represented in which one member 306 is absent. According to the current disclosure, when a first member invites another member to the social set 1300, the invitee may join the session or may alternatively be absent. Where an invitee 306 is absent, the social DVR system may allow the inviter to be provided with permission to record the shared media session 1100 on the absent invitee's DVR 306′ such as an HDD or the like.

For illustrative purposes only and so as to better explain possible applications of the disclosure the following examples are presented. It is noted that the selection of applications is not to be considered exhaustive and that other applications will occur to those in the art.

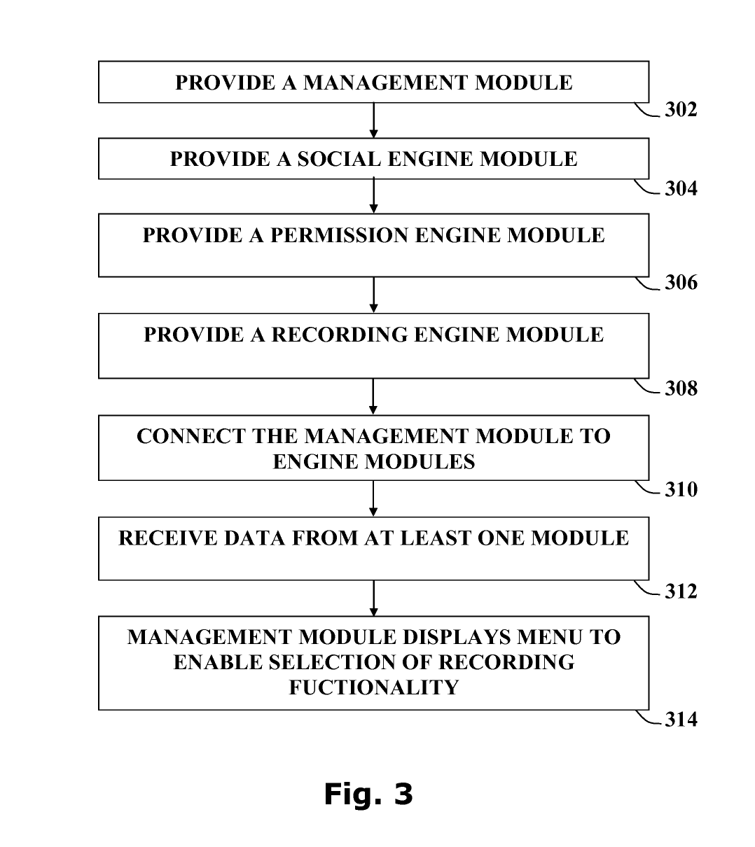

Referring to the flowchart of FIG. 3, a method is disclosed for managing remote recording of media content. The method includes the steps: providing a management module 302; providing a social engine module 304; providing a permission engine module 306; providing a recording engine module 308; connecting the management module to the engine modules including the social module, the permission module and the recording module 310; receiving data from at least one engine module, typically via the management module 312; and the management module presenting an output menu to a user to enable remote recording functionality 314.

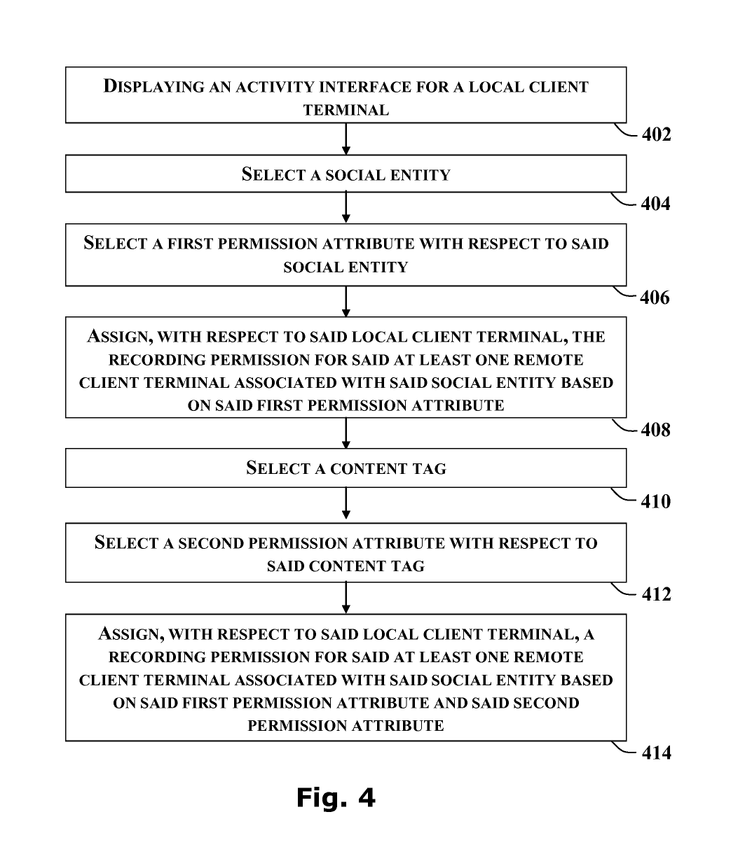

Referring now to the flowchart of FIG. 4, various selected actions are illustrated of a possible method for providing social DVR activities and handling recording permissions for a member of a social group. It will be appreciated that other methods may be used. The method may be used in a remote DVR recording management system such as described herein and may be related for example, with a management system such as described in the applicants co-pending applications relating to hybrid advertising, U.S. Ser. No. 61/605,220, and group purchase offers.

The disclosure may provide for a method for assigning a recording permission for at least one remote client terminal comprising the following steps: Displaying an activity interface for a local client terminal (402); Selecting a social entity (404); Selecting a first permission attribute with respect to said social entity (406) and; Assigning, with respect to said local client terminal, the recording permission for said at least one remote client terminal associated with said social entity based on said first permission attribute (408).

The method may further include the following steps: Selecting a content tag (410); and Selecting a second permission attribute with respect to said content tag (412); and Assigning, with respect to said local client terminal, a recording permission for said at least one remote client terminal associated with said social entity based on said first permission attribute and said second permission attribute (414).

The selection of the social entity (404) by the user may be conducted through various methods, such as keyword searching, navigating menus having lists of potential social entities, and the like. Further, suggestions of social entities to select may be presented to the user through the activity interface of the client terminal or other methods, such as email, website advertisements, popups, interactive television advertisements and the like, which may include a link to direct the user to the activity interface for the client terminal. The suggestion of the social entities may be based on the preference profile of the user, and may further be based on the preference profile of the suggested social entity.

The social entity may be one or more of a social group, a social set, or a social group member.

The media content may be television shows, radio shows, podcasts, downloads, movies, video clips, slideshows, multimedia presentations, pictures, games, music, audio clips as well as combinations thereof and the like.

The client terminal may be, or be associated with, without restriction, a television set, a set-top-box (STB), a desktop computer, a laptop computer, a tablet, a telephone, a PDA, a mobile communication device or the like. The client terminal may include, be externally connected to, or otherwise associated with a digital video recorder (DVR). The STB may be a cable television STB.

‘NONE’ may serve as a default permission attribute, not allowing any remote recording functionality. The selected permission attribute may be, for example, ‘ALLOWED’ or ‘NOT ALLOWED’. Alternatively or additionally, the permission constructs may support a wider range enabling enhanced functionality. Such definitions, for example, may comprise a variety of permission attributes such as ‘NONE’, ‘WRITE’, ‘READ’, ‘READ-WRITE’ and ‘DELETE’. ‘WRITE’ may grant permission for recording new content only. ‘READ’ may allow viewing of recorded content only and ‘READ-WRITE’ may allow recording and viewing as described hereinabove. ‘DELETE’ may allow removing of recorded programs to manage DVR space limitations issues.

Media content may be associated with one or more social entities and/or one or more content tags. The selection of the permission attribute of ‘ALLOWED’ may grant permission for the selected social entity to record media content onto the DVR associated with the client terminal. The following are examples:
A user selects ‘ALLOWED’ with respect to social group A, allowing the recording of media content selected for sharing in social group A by any member of said social group.
A user selects ‘ALLOWED’ with respect to member B, allowing the recording of all media content selected by member B for sharing.

Further, the allowance for media content to be recorded onto the DVR associated with the client terminal may depend on the context of the permission attribute. That is, the allowance for media content to be recorded onto the DVR associated with the client terminal may depend on the interaction of multiple permission attributes associated with a particular media content.

The permission attribute of ‘NOT ALLOWED’, for example, is typically relevant in combination with other ‘ALLOWED’ attributes associated with a particular media content. The selection of the permission attribute of ‘NOT ALLOWED’ may block the recording of the media content that would otherwise be granted for DVR recording with the client terminal. The following are examples:
A user selects ‘ALLOWED’ with respect to social group A, allowing the recording of media content selected for social group A by any member of said social group to be recorded. However, the user also selects ‘NOT ALLOWED’ with respect to a user B that is a member of social group A. As a result, media content associated with social group A that is selected by user B is blocked.
A user selects ‘ALLOWED’ with respect to member B, allowing the recording of all media content selected by member B, individually or in the context of any social group. However, the user also selects ‘NOT ALLOWED’ with respect to a social group A. As a result, media content selected by user B for social group A is blocked.
A user selects ‘ALLOWED’ with respect to social group A, allowing the recording of media content selected for social group A by any member of said social group to be recorded. However, the user also selects ‘NOT ALLOWED’ with respect to a content tag C. As a result, media content associated with social group A that is also associated with the content tag C is blocked.

In the above, examples, the ‘NOT ALLOWED’ permission attribute is configured to be controlling. However, other rules for combining multiple permission attributes are possible. The combination rules may be predetermined, or selected by the user. The following are examples of combination rules:
The permission attribute of the more specific social entity may control a more general social entity (i.e., the permission attribute of the social group may be controlled by the permission attribute of the social set, and the permission attribute of thes social set may be controlled by the permission attribute of the member).
The permission attribute of the more general social entity may control a more specific social entity (i.e., social group may control the permission attribute of the social set, and the permission attribute of the social set may control the permission attribute of the member).
The permission attribute of a content tag may have control over the permission attribute of a social entity.
The permission attribute of a social entity may have control over the permission attribute of a content tag.
Permission attributes may be prioritized by social entity, for example one social entity may be assigned priority over another social entity. So, for example, a first social entity may be prioritized such that they are able to access a DVR at any time, whereas a second social entity may be provided access only if the first social entity is not already accessing the DVR.
Permission attributes may be prioritized by content type, for example one content type may be assigned priority over another content type. So, for example, access may be provided to a DVR for a first content type at any time, whereas access may be provided to the DVR for a second content type only the DVR is not already being accessed.
Other rules may occur to a person skilled in the art.

A social group may allow only a subset of the members to have content sharing privilege. As such, a more refined set of permission attributes, such as ‘WRITE’, ‘READ’, ‘READ-WRITE’, may be used. ‘WRITE’ may grant permission to share media content, e.g., to remotely instruct the DVR of another client terminal to record selected media content. ‘READ’ may allow viewing of recorded content only and ‘READ-WRITE’ may allow recording and viewing as described hereinabove. As such:
A user that selects ‘READ’ with respect to a social entity X allows social entity X to share media content (e.g., social entity X may remotely instruct the DVR of the user's client terminal to record the media content selected by the social entity X) but the user cannot share media content with social entity X (e.g., the user cannot instruct other client terminal(s) associated with social entity X to record media content).
A user that selects ‘WRITE’ with respect to a social entity X allows the user's client terminal to share media content with social entity X (e.g., the user's client terminal may remotely instruct the DVR of the client terminal(s) associated with social entity X to record the media content selected the user) but social entity X or members thereof cannot share media content with the user (e.g., social entity X may not instruct the DVR of the user's client terminal to record media content).
A client terminal associated with a permission attribute of ‘READ-WRITE’ with respect to a social entity may share media content with said social entity, and social entity may share media content with the client terminal.

Using the ‘WRITE’, ‘READ’, ‘READ-WRITE’ permission attributes, it is possible to create, e.g., a virtual channel that has the content controlled by one member (or a subset of members) of a social group. A social group may be configured such that a member joining the group only receives a ‘READ’ permission attribute, while an administrator member has a ‘WRITE’ permission attribute.

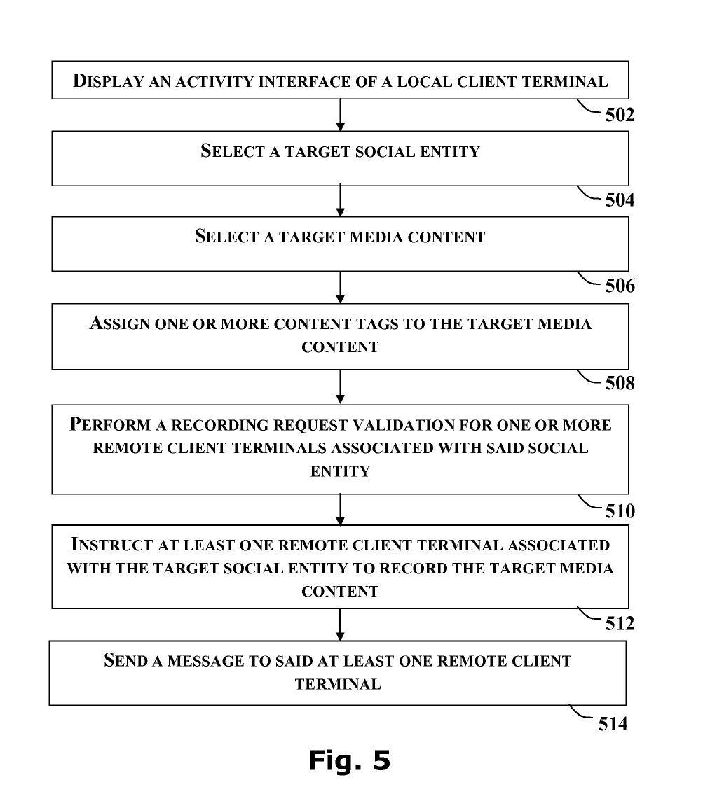

Referring now to the flowchart of FIG. 5, various selected actions, are illustrated of a possible method for controlling recording activity in one or more remote client terminals, i.e., providing social DVR activities and handling recording for a social group member. The method may be used in a remote DVR recording management system, such as described herein and may be related for example, with a management system such as described in the applicants co-pending application relating to hybrid advertising and group purchase, U.S. Ser. No. 61/605,220, and group purchase offers.

It is noted that the functionality described hereinbelow may be executed by a processor integrated into a client terminal such as a set top box or the like, which may be configured accordingly, as described hereinabove in relation to FIGS. 1-3.

The disclosure may provide for a method for remote recording comprising the following steps:

Displaying an activity interface of a local client terminal (502); Selecting a target social entity (504); Selecting a target media content (506); Instructing at least one remote client terminal associated with the target social entity to record the target media content (512).

Optionally, the method may further include the step of assigning one or more content tags to the target media content (508).

Optionally, the method may further include the step of performing a recording request validation for one or more remote client terminals associated with said social entity (510).

The target social entity may be one or more of a social group, a social set, or a social group member.

The media content may be television shows, radio shows, podcasts, downloads, movies, video clips, slideshows, multimedia presentations, pictures, games, music, audio clips and the like.

The client terminal may be or be associated with, without restriction, a television set, a set-top-box (STB), a desktop computer, a laptop computer, a tablet, a telephone, a PDA, a mobile communication device or the like. The client terminal may include, be externally connected to, or otherwise associated with a digital video recorder (DVR). The STB may be a cable television STB.

Validation of the recording request may be based on the permission attributes assigned to the local client terminal with respect to the target social entity, and with respect to the content tags associated with the target media content.

Optionally, an appropriate message may be sent to the owner(s) of said at least one remote client terminal associated with the selected social entity. (514). The message may further be sent to other social entities connected to said owners, e.g., friends, other social groups, and the like.

The selection of the target social entity (504), as well as the selection of the target media content (506), by the user may be conducted through various methods, such as keyword searching, navigating menus having lists of potential social entities, and the like. The selection of the target media content (506) may be conducted through a TV program schedule. Further, suggestions of target social entities, as well as target media content, to select may be presented to the user through the activity interface of the client terminal or other methods, such as email, website advertisements, popups, interactive television advertisements and the like, which may include a link to direct the user to the activity interface for the client terminal. The suggestion of the social entities and media content may be based on the preference profile of the user, and may further be based on the preference profile of the suggested social entity or the content tags associated with the media content. Further, the suggestion of the target media content may be based on the selected target social group. Alternatively, the suggestion of the target social group may be based on the selected media content.

The methods and systems described herein may be deployed in part or in whole through a machine or device that executes computer software, program codes, and/or instructions on a processor. The processor may be part of a server, client, network infrastructure, mobile computing platform, stationary computing platform, or other computing platform. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

The methods and systems described herein may be deployed in part or in whole through a machine that executes computer software on a server, client, firewall, gateway, hub, router, or other such computer and/or networking hardware.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The scope of the disclosed embodiments may be defined by the appended claims and includes both combinations and sub combinations of the various features described hereinabove as well as variations and modifications thereof, which would occur to persons skilled in the art upon reading the foregoing description.

Technical and scientific terms used herein should have the same meaning as commonly understood by one of ordinary skill in the art to which the disclosure pertains. Nevertheless, it is expected that during the life of a patent maturing from this application many relevant systems and methods will be developed.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A method for assigning a recording permission for at least one remote client terminal comprising the steps of:
displaying an activity interface for a local client terminal;
selecting a social entity;
selecting a first permission attribute with respect to said social entity; and
assigning, with respect to said local client terminal, the recording permission for said at least one remote client terminal associated with said social entity based on said first permission attribute.

2. The method of claim 1 further comprising the steps of:
selecting a content tag;
selecting a second permission attribute with respect to said content tag; and
assigning, with respect to said local client terminal, a recording permission for said at least one remote client terminal associated with said social entity based on said second permission attribute.

3. The method of claim 1, wherein selection of the social entity is conducted through a method selected from the group consisting of: keyword searching, navigating menus having lists of potential social entities.

4. The method of claim 1, wherein the selection of the social entity is preceded by a presentation of one or more suggested social entities.

5. The method of claim 4, wherein said one or more suggested social entities are presented through the activity interface of the local client terminal.

6. The method of claim 4, wherein said one or more suggested social entities are presented through one or more vehicles selected from the group consisting of: email, website advertisements, popups, interactive television advertisements.

7. The method of claim 6, wherein said vehicle comprises a link to the activity interface for the local client terminal.

8. The method of claim 4, wherein said one or more suggested social entities are selected based on a preference profile assigned to the local client terminal.

9. The method of claim 8, wherein the selection of said one or more suggested social entities are selected based on the preference profile of said one or more suggested social entities.

10. The method of claim 1, wherein the social entity is selected from the group consisting of: a social group, a social set, and a social group member.

11. The method of claim 1, wherein the media content may be selected from the group consisting of: television shows, radio shows, podcasts, downloads, movies, video clips, slideshows, multimedia presentations, pictures, games, music, audio clips and combinations thereof.

12. The method of claim 1, wherein the client terminal comprises, a television set, a set-top-box (STB), a desktop computer, a laptop computer, a tablet, a telephone, a PDA, a mobile communication device and combinations thereof.

13. The method of claim 1, wherein the permission attribute is selected from the group consisting of ‘NONE’, ‘ALLOWED’, ‘NOT ALLOWED’, ‘WRITE’, ‘READ’, and ‘READ-WRITE’, wherein:
‘NONE’ is a default permission attribute configured to not allow remote recording;
‘ALLOWED’ is configured to grant permission for the selected social entity to remotely record media content onto the DVR device of the client terminal;
‘NOT ALLOWED’ is configured to block the recording of media content that would otherwise be granted for remote DVR recording with the client terminal;
‘READ’ is configured to allow the selected social entity to remotely record media content onto the DVR device of the client terminal but not allow the client terminal to remotely record media content for the selected social entity;
‘WRITE’ is configured to allow the client terminal to remotely record media content for the selected social entity but not allow the selected social entity to remotely record media content onto the DVR device of the client terminal; and
‘READ-WRITE’ is configured to allow the client terminal to remotely record media content for the selected social entity and to allow the selected social entity to remotely record media content onto the DVR device of the client terminal.

14. A method for controlling recording activity in one or more remote client terminals having the steps of:
Displaying an activity interface of a local client terminal;
Selecting a target social entity;
Selecting a target media content; and
Instructing at least one remote client terminal associated with the target social entity to record the target media content.

15. The method of claim 14 further comprising the step of performing a recording request validation for said one or more remote client terminals associated with the target social entity.

16. The method of claim 15, wherein the recording request validation is based on one or more permission attributes assigned to the local client terminal with respect to the target social entity.

17. The method of claim 14 further comprising the step of assigning one or more content tags to the target media content.

18. The method of claim 17, wherein the recording request validation is based on the content tags associated with the target media content.

19. The method of claim 14 further comprising the step of sending a message to said at least one remote client terminal.

20. The method of claim 14, wherein selection of the target social entity and the selection of the target media content is conducted through a method selected from the group consisting of: keyword searching, navigating menus having lists of potential social entities.

21. The method of claim 14, wherein the selection of the target social entity and the target media content is preceded by a presentation of one or more suggested social entities and one or more suggested media content.

22. The method of claim 21, wherein said one or more suggested target social entities and said one or more suggested target media content are presented through the activity interface of the local client terminal.

23. The method of claim 21, wherein said one or more suggested target social entities and said one or more suggested target media content are presented through one or more vehicles selected from the group consisting of: email, website advertisements, popups, interactive television advertisements.

24. The method of claim 23, wherein said vehicle comprises a link to the activity interface for the local client terminal.

25. The method of claim 21, wherein said one or more suggested target social entities and said one or more suggested target media content are selected based on a preference profile assigned to the local client terminal.

26. The method of claim 25, wherein the selection of said one or more suggested target social entities and said one or more suggested target media content are further based on the preference profile of said one or more suggested social entities.

27. The method of claim 14, wherein the target social entity is selected from the group consisting of: a social group, a social set, and a social group member.

28. The method of claim 14, wherein the target media content may be selected from the group consisting of: television shows, movies, video clips, slideshows, pictures, games, and music.

29. The method of claim 14, wherien the client terminal comprises a television set, a set-top-box (STB), a desktop computer, a laptop computer, a tablet and a mobile communication device.
